(19) United States
(12) Patent Application Publication
(10) Pub. No.: US 2004/0080533 A1
(43) Pub. Date: Apr. 29, 2004

(54) Accessing rendered graphics over the internet

(75) Inventors: Satyanarayana Nishtala, Cupertino, CA (US); Peter Denyer, Fremont, CA (US)

Correspondence Address: BRIAN M BERLINER, ESQ, O'MELVENY & MYERS, LLP, 400 SOUTH HOPE STREET, LOS ANGELES, CA, 90071-2899, US

(73) Assignee: SUN MICROSYSTEMS, INC.

(21) Appl. No.: 10/278,697

(22) Filed: Oct. 23, 2002

(51) Int. Cl. G09G 5/00

(52) U.S. Cl. 345/748

(57) ABSTRACT

A system and method for accessing rendered graphics over a computer network is described. In accordance with one or more exemplary embodiments of the invention, an application renders graphics on a server machine in response to a request from a client, takes a snapshot of the output of the rendered graphical images, compresses the rendered images, and sends them through the computer network to the client. On the client's side, the compressed, rendered snapshot images are decompressed and displayed. The rendered-graphics experience is the same as if the application were rendered on the local machine. Exemplary embodiments may be configured to use lossless compression schemes like GIF and also lossy compression schemes like JPEG and MPEG. In one exemplary embodiment, the client machine uses a web browser to view the snapshots of the rendered images after they are uncompressed by the client.

### BACKGROUND OF THE INVENTION

1. Field of the Invention

The present invention relates to the field of computer graphics and, in particular, to accessing rendered graphics over a computer network.

2. Background Art

For many computer applications, graphics are rendered by the computer and viewed by the user. Currently, all graphics are rendered on the user's local computer. More recently, resource intensive applications (e.g., processing and storage applications) are being shifted to centralized servers to minimize hardware and software costs. Furthermore, the advent of the Internet has created a need to access these centralized computer resources over the Web.

Moreover, a number of applications use high performance graphics rendering engines to display complex information or objects in graphical form. A high performance interface to the graphics rendering engine is required for acceptable performance. If these applications must be web-enabled, to create a web-portal, for example, then the software interfaces, the network bandwidth to the web device, and the rendering capabilities of the device become bottlenecks in web-enabling these applications. Accordingly, there is a need for providing rendered graphics to local computers in a computer system without a loss in performance.

### SUMMARY OF THE INVENTION

The present invention is a system and method for accessing rendered graphics over a computer network. An exemplary embodiment relates to the accessing of rendered graphics over the Internet. According to an exemplary embodiment of the present invention, an application renders graphics on a server machine in response to a request from a client, takes a snapshot of the output of the rendered graphical images, compresses the rendered images, and sends them through the Internet to the client. On the client's side, the compressed, rendered snapshot images are decompressed and displayed. The rendered-graphics experience is the same as if the application were rendered on the local machine. Alternate exemplary embodiments may use lossless compression schemes like GIF or lossy compression schemes like JPEG or MPEG. In one exemplary embodiment, the client machine uses a web browser to view the snapshots of the rendered images after they are uncompressed by the client.

A more complete understanding of the system and method for accessing rendered graphics over a computer network will be afforded to those skilled in the art, as well as a realization of additional advantages and objects thereof, by a consideration of the following detailed description of the preferred embodiments. Reference will be made to the appended sheets of drawings which will first be described briefly.

### BRIEF DESCRIPTION OF THE DRAWINGS

FIG. 1 is a block diagram of a three-tier architecture.

FIG. 2A is a flow diagram showing an overview of accessing graphics over a computer network according to an exemplary embodiment of the present invention.

FIG. 2B is a flow diagram of rendering graphics on the server side and viewing the graphic by the client using a browser according to an exemplary embodiment of the present invention.

FIG. 3 is a flow diagram illustrating a server-side process during rendering of graphics according to an exemplary embodiment of the present invention.

FIG. 4 is a flow diagram illustrating a client-side process during rendering of graphics according to an exemplary embodiment of the present invention.

FIG. 5 is a flow diagram showing compression during the rendering of graphical images according to an exemplary embodiment of the present invention.

FIG. 6 is a flow diagram showing the compression process on a server according to an exemplary embodiment of the present invention.

FIG. 7 is a flow diagram showing the decompression process on a client according to an exemplary embodiment of the present invention.

### DETAILED DESCRIPTION

The present invention provides a system and method for accessing rendered graphics over a computer network. In the following detailed description, like element numerals are used to describe like elements illustrated in one or more drawings.

Overview of the Three-Tier Architecture

FIG. 1 provides an exemplary embodiment of a multi-tier computer system. Client tier 100 typically includes a computer that provides a graphic user interface (GUI) generated by a Client 110, such as a web browser or other user interface application. Conventional browsers include Internet Explorer™ and Netscape Navigators™, among others Client 110 generates a display from, for example, a specification of GUI elements, an applet, or both. An example of a specification of GUI elements includes a file containing input, form, and text elements defined using the Hypertext Markup Language (HTML). An example of an applet includes a program written using a platform-independent programming language, such as Java™, that runs when it is loaded by the browser.

Further application functionality is provided by application logic managed by application server 120 in application tier 130. The apportionment of application functionality between client tier 100 and application tier 130 may be based upon whether a “thin client” or “thick client” topology is desired. In a thin-client topology, the client tier is limited in functionality, in that the end user's computer on the client tier 100 is used primarily to display output and obtain input, while computing takes place in the application tier 130. A thick-client topology, on the other hand, uses a more conventional general purpose computer having processing, memory, and data storage abilities. Database tier 140 contains the data that is accessed by the application logic in application tier 130. Database server 150 manages the data, its structure, and the operations that can be performed on the data, its structure or both.

Application server 120 can include applications such as a corporation's scheduling, accounting, personnel, and payroll applications, for example. Application server 120 manages requests for the applications that are stored therein. Application server 120 can also manage the storage and dissemination of production versions of enterprise application logic (e.g., the versions that are currently being used by the corporate users). Database server 150 manages the database or databases that manage data for the applications. Database server 150 responds to requests to access the scheduling,, accounting, personnel, and payroll applications' data, For example.

Connection 160 is used to transmit enterprise data between client tier 100 and application tier 150 and may also be used to transfer the enterprise application logic to client tier 100. The client tier 100 can communicate with the application tier 130 via, for example, a Remote Method Invocator (RMI) application programming interface (API) available from Sun Microsystems™, located in Santa Clara, Calif. The RMI API provides the ability to invoke software modules that reside on another computer system. Parameters are packaged and unpackaged for transmittal to and from the client tier 100. Connection 170 between application server 120 and database server 150 represents the transmission of requests for data and the responses to such requests from applications that reside in application server 120.

Elements of the client tier, application tier and database tier (e.g., client 110, application server 120, and database server 150, respectively) may execute within a single computer. However, in a typical system, elements of the client tier 100, application tier 130 and database tier 140 may execute within separate computers interconnected over a computer network, such as, for example, a LAN (local area network) or WAN (wide area network). For instance, the computers may be interconnected over the Internet.

Rendering

Software programs interact with the user, and computer graphics enhance the interaction. Computer graphics are used to display pictorial information. Users expect to control their computer through icons and other pictures and graphics. Rendering is the process whereby a computer performs a graphics calculation and transfers the calculation to a display, such as a monitor.

Generally, rendering is a complicated process. First, the computer must perform rigorous calculations to determine which pixels on the screen are to be drawn and which color each pixel should be. This process typically requires specialized hardware and software that is not present on all client systems. Many of the current graphical-rendering applications are currently incapable of performing in Such an environment. The present invention allows a user to access rendered (graphics in a multi-tier computer system. Other exemplary embodiments also enable the sharing of high-end and expensive graphics-intensive applications across multiple client devices.

Accessing Rendered Graphics

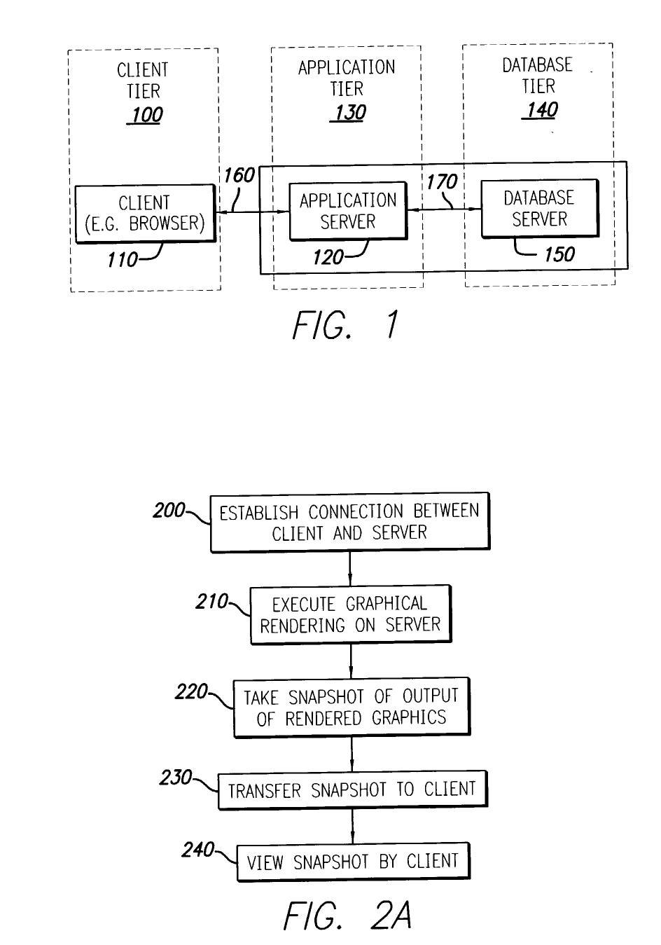

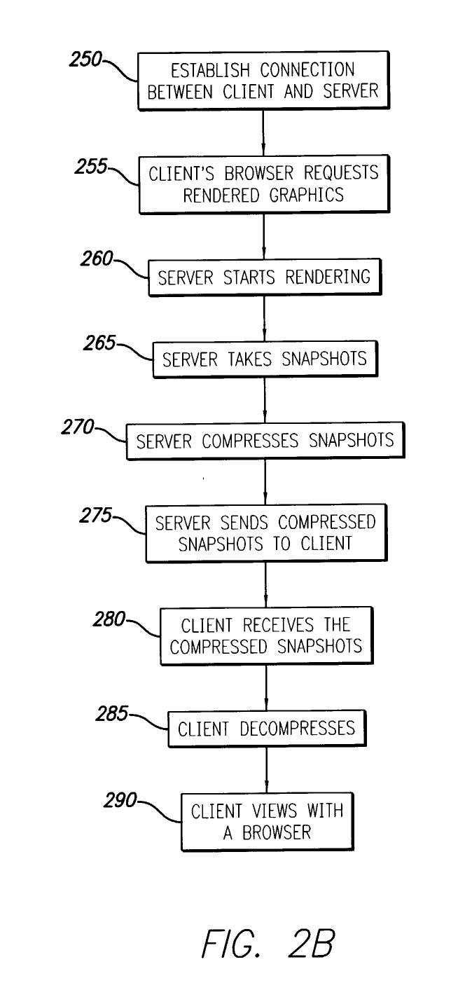

FIG. 2A is an illustration of the process of accessing rendered graphics over a computer network according to one exemplary embodiment of the present invention. At step 200, a connection is established between a client and a server. At step 210, graphical rendering is performed on the server. A snapshot is then taken of the rendered graphical images on the server at step 220. These snapshots are transferred to the client at step 230 and viewed the client at step 240. As discussed above, the computer network may be a LAN, WAN or any other type of network. In one exemplary embodiment, the computer network is the Internet.

The user may use any program suitable for viewing graphics to view the images. For example, in one exemplary embodiment of the present invention, the user may use a web browser such as Internet Explorer™ or Netscape Navigator™ to view the images upon receipt. This exemplary embodiment is shown in FIG. 2B. At step 250, the client and server establish a connection with each other for communication over the computer network. As discussed above, the computer network may be the Internet, for example. The client's browser makes a request to the server which requires rendered graphics at step 255. Upon receiving the request, the server starts rendering at step 260. At step 265, the server takes snapshots of the rendered graphical images. The server compresses these snapshots at step 270. These compressed images are sent to the client over the computer network at step 275. Client receives these compressed snapshot images at step 280 and decompresses them at step 285. The decompressed image is viewed using a browser at step 290.

For conventional downloads of graphical interfaces from the Web, content is created before it is presented on the Web or the content is compressed on-line for live video, for example. In contrast, the system and method of the present invention compresses rendered graphics in real-time for display over a network or for a web-based client. As a result, a number of advantages may be achieved. For instance, as discussed above, graphics rendering systems can be quite expensive, depending on the sophistication of the function being rendered. For example, a detailed rendering of a car, with realistic lighting and rendered in real time to dynamically show the point of view, requires the combination of sophisticated and costly hardware and software. Conventional systems require the display system to be local to the rendering platform. Accordingly, conventional systems do not allow this type of rendering over computer networks such as the Web, intranet or extranet, for example. As discussed herein, the present invention allows a system to render graphics on a graphics server connected to a network, such as, for example, the Web, and allows the rendered picture to be seen on any web-browser or similar display application.

Server-Side Rendering

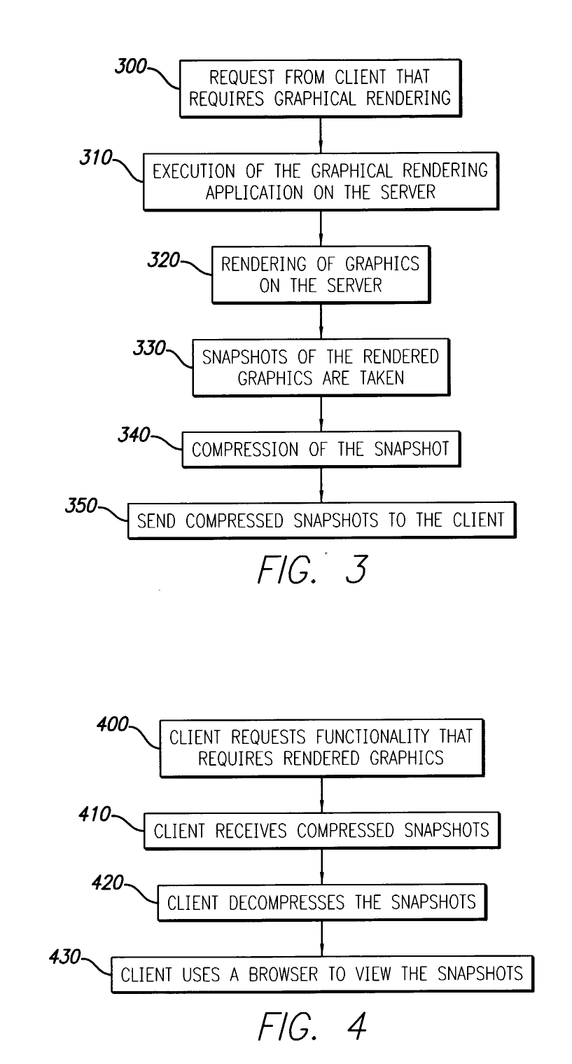

FIG. 3 is an illustration of the process that occurs when the client makes a request that requires graphical rendering according to an exemplary embodiment of present invention. A server receives a request from a client that requires graphical rendering at step 300. The server starts executing the graphical-rendering application at step 310. At step 320, the rendering of the graphics is performed on the server, and one or more snapshots of these rendered graphics arc taken at step 330. The snapshots are then compressed at step 340 and sent to a user machine (e.g., client) over the computer network at step 350.

Client-Side Process

FIG. 4 is an Illustration of an exemplary embodiment of the process from the client-side, e.g., user machine. The user machine first determines that it needs functionality that requires graphical rendering at step 400. Upon receiving the request for rendering functionality, a server renders the graphics, after which compressed snapshots of the rendered graphical images are sent to the user machine. For example, the snapshots may be created and compressed as shown in the exemplary embodiment illustrated in FIG. 3. The user machine receives the compressed snapshots at step 410. In another exemplary embodiment, the compressed snapshots may be decompressed by other client-side computers before being delivered to the user machine. The compressed snapshots are decompressed at step 420 and viewed on a browser or any other application suitable for viewing graphics at step 430. The experience in terms of the quality of the graphics and speed of processing the application is the same as the experience when graphical rendering is performed on the user machine itself.

Compression

Compression is used because it enables the server to transmit the same amount of data in fewer bits, which saves bandwidth. Compression is performed to reduce the size of the data in order to save space and transmission time. In one exemplary embodiment of the present invention, a compression is performed on just the data content. In another exemplary embodiment of the present invention, a compression is performed on the entire transmission unit, including header data. In one exemplary embodiment, one method of content compression is to remove all extra space characters, insert a single repeat character to indicate a string of repeated characters, and substitute smaller bit strings for frequently occurring characters. In one exemplary embodiment, the compression or the rendered image may be performed using industry standard image compression protocols, such as JPEG, for example. In another exemplary embodiment of the present invention, a proprietary compression algorithm, known to both the client and the server systems, may be used.

One exemplary embodiment of the present invention uses a lossless compression technique to compress the snapshots of the rendered graphics. A lossless compression scheme is a data compression technique in which substantially no data is lost. With lossless compression, substantially every bit of data that was originally in the file remains after the file is uncompressed. Substantially all of the information is completely restored. This technique is preferably used while rendering text or spreadsheet files. One example of lossless compression is the Graphics Interchange File (GIF). One exemplary embodiment of the present invention uses the GIF format. GIF provides lossless compression and is generally used as an image format for Internet-based applications. The GIF format ensures that substantially all of the information in the original file is preserved after compression. This format also maintains the full quality of the original file.

In another exemplary embodiment of the present invention, a lossy compression technique is used to eliminate information that is not critical to creating an acceptable approximation of the original image. Examples of lossy compression techniques include the Moving Pictures Expert Group (MPEG) format and the Joint Photographic Experts Group (JPEG) format. Lossy compression reduces a file by permanently eliminating certain information. When the file is decompressed, only a part of the original information remains. Lossy compression is generally used for video and sound, where a certain amount of information loss will not be detected by most users. Lossy compression may be used for images. For example, the JPEG image file, commonly used for photographs and other complex still images on the Web, is a format that has lossy compression. Lossy compression offers the flexibility to decide on the quality of the picture versus the size of the file and the data transfer rate, so that the server can tailor the file according to the client's need. The performance of lossy-compression algorithms is most often expressed in operational rate-distortion curves, which are obtained by varying the compression parameter, such as a quality factor or a target compression ratio. The two variables generally used for these plots are the compression ratio and the Peak-Signal-to-Noise Ratio, which is a logarithmic function of the mean square between the original and reconstructed images.

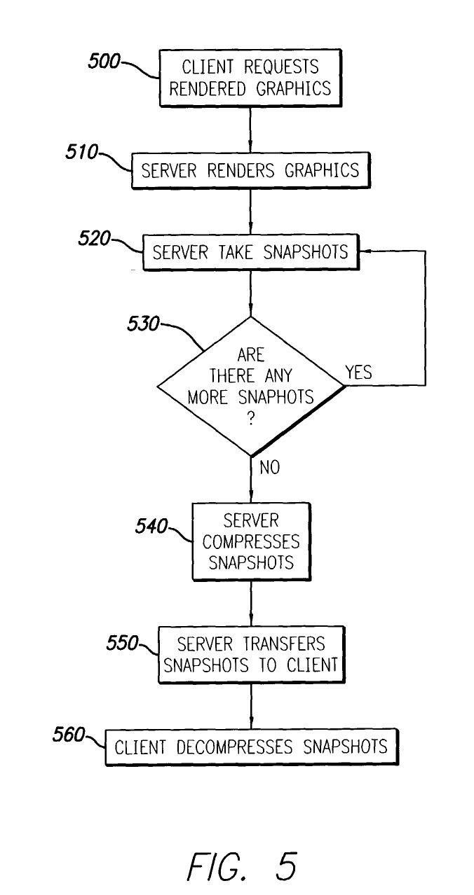

FIG. 5 is an illustration of a compression process according to one exemplary embodiment of the present invention. A client requests rendered graphics at step 500. A server receives the request and renders the graphics at step 510. Snapshots are taken of the rendered graphics on the server at step 520. A check is made to see whether all the rendered graphic images have had snapshots taken at step 530. If the check result returns a positive answer, then the process at step 520 is repeated to take snapshots of remaining rendered graphics. If the check result returns a negative answer (e.g., no more snapshots to be taken), the process of compressing the snapshots takes place at step 540, for instance, using, JPEG or MPEG compression. The compressed snapshots are sent to the client at step 550 and decompressed by the client at step 560.

Compression Process on Server

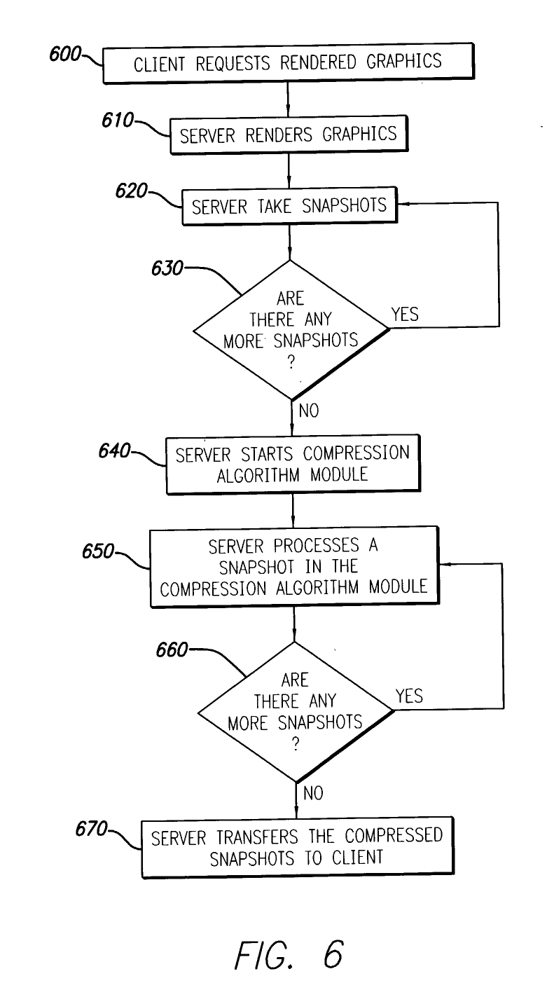

FIG. 6 is an illustration of tie compression process on a server when rendering graphics according to an exemplary embodiment of the present invention. A client requests that a server render graphics at step 600. A server renders the graphics at step 610. The server takes snapshots of the rendered graphical images at step 620. A check is made to see whether there are any more snapshots to be taken at step 630. If the check result returns a positive answer, then the process at step 620 is repeated to take snapshots of remaining rendered graphics. If the check result returns a negative answer (e.g., no more snapshots to be taken), the server starts a compression-algorithm module at step 640. The server processes a snapshot in the compression-algorithm module at step 650. A check is made to see whether any snapshot images have been left to be processed in the compression-algorithm module at step 660. If the check result returns a positive answer, then the process at step 650 is repeated to process the remaining snapshots in the compression-algorithm module. If the check result returns a negative answer (e.g., no more snapshots to be processed), the server transfers the compressed snapshots to the client over the computer network at step 670. As discussed above, the computer network may be the Internet, for example.

Decompression Process on Client

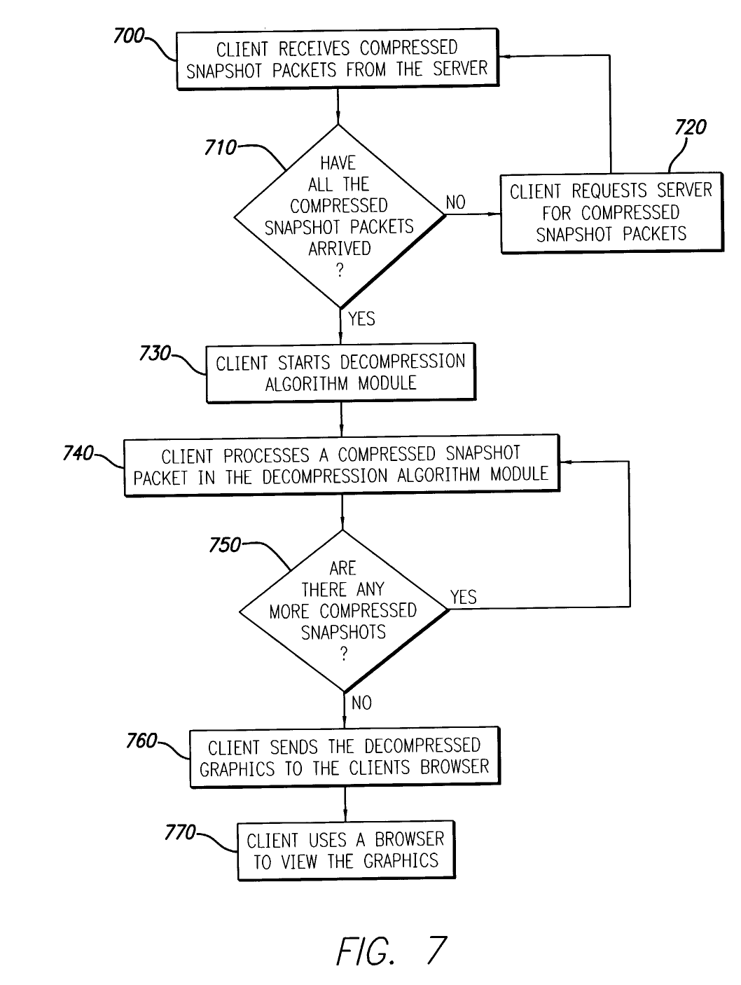

FIG. 7 is an illustration of the decompression process on the client-side after rendering graphics on the server according to an exemplary embodiment of the present invention. A client (e.g., a computer on the client-side) receives compressed snapshot images as packets over the computer network from a server at step 700. A check is made to see whether all the compressed snapshot images have arrived to the client at step 710. If the check result returns a negative answer, then a request is sent to the server for the required compressed snapshots at step 720, and the process at step 700 is repeated. If the check result returns a positive answer because all the compressed snapshots arrived, the client starts the decompression-algorithm module at step 730. The client processes a compressed snapshot in the decompression-algorithm module at step 740. A check is made to see whether any compressed snapshot images have yet to be decompressed at step 750. If the check result returns a positive answer, then the process at step 740 is performed until all the remaining compressed snapshot images are decompressed. If the check result returns a negative answer (e.g., no more compressed snapshots present), the client sends the decompressed graphical image to the browser at step 760. The client uses a browser to view the graphics at 770.

Having described the preferred embodiments of the system and method for accessing, rendered graphics over a computer network, it should be apparent to those skilled in the alt that certain advantages of the described system and method have been achieved. It should also be appreciated that various modifications, adaptions and alternative embodiments thereof may be made within the scope and spirit of the present invention. For example, the present invention may be practiced using any combination of hardware, software or both. This invention is further defined by the following claims and their full scope of equivalents.

We claim:

1. A method for accessing graphics over a computer network for a computer system comprising a client-side system and a server-side system comprising:
receiving a request from a client associated with the client-side system, wherein the request comprises a request for a rendered graphic;
performing a graphical rendering process;
taking a snapshot of an output of the graphical rendering process;
compressing the snapshot; and
sending the compressed snapshot to the client-side system.

2. The method of claim 1, further comprising the step of receiving a request for a snapshot from the client.

3. The method of claim 1, wherein the step of compressing the snapshot further comprises:
starting a compression algorithm module; and
processing a snapshot in the compression algorithm module.

4. The method of claim 1, wherein the step of compressing the snapshot further comprises using a lossless compression scheme.

5. The method of claim 4, wherein the step of using a lossless compression scheme further comprises using a Graphic Interchange File (GIF) scheme.

6. The method of claim 1, wherein the step of compressing the snapshot further comprises using a lossy compression scheme.

7. The method of claim 6, wherein the step of using a lossy compression scheme further comprises using an Motion Pictures Experts Group (MPEG) scheme.

8. The method of claim 6, wherein the step of using a lossy compression scheme further comprises using, a Joint Photographic Experts Group (JPEG) Scheme.

9. The method of claim 1, wherein the step of taking a snapshot further comprises the step of determining whether a snapshot has been taken for all of the output of the graphical rendering process.

10. A computer system operable to access rendered graphics across a computer network, comprising a server-side system comprising a server, wherein the server system is operable to:
receive a request over the computer network from a client-side system comprising a client, wherein the request requires graphical rendering;
perform a graphics rendering in accordance with the request to produce a rendered graphics;
take a snapshot of the rendered graphics;
compress the snapshot to produce a compressed snapshot; and
transmit the compressed snapshot to the client-side system.

11. The computer system of claim 10, wherein the computer network is a local area network (LAN).

12. The computer system of claim 10, wherein the computer network is a wide area network (WAN).

13. The computer system of claim 12, wherein the computer network is an Internet.

14. The computer system of claim 10, wherein the server-side system is operable to receive a request for a snapshot from the client-side system.

15. The computer system of claim 14, wherein the server-side system further comprises a compression module operable to process a snapshot in accordance with a selected compression algorithm.

16. The computer system of claim 10, wherein the server-side system is operable to compress the snapshot in accordance with a lossless compression technique.

17. The computer system of claim 16, wherein the compression technique is a Graphics Interchange File (GIF) scheme.

18. The computer system of claim 10, wherein the server system is operable to compress the snapshot in accordance with a lossy compression technique.

19. The computer system of claim 18, wherein the compression technique is a Joint Photographic Experts Group (JPEG) scheme.

20. The computer system of claim 18, wherein the compression technique is a Motion Pictures Experts Group (MPEG) scheme.
